(19) United States
(12) Patent Application Publication
(10) Pub. No.: US 2010/0195868 A1
(43) Pub. Date: Aug. 5, 2010

(54) TARGET-LOCKING ACQUISITION WITH REAL-TIME CONFOCAL (TARC) MICROSCOPY

(76) Inventor: Peter J. Lu, Cambridge, MA (US)

Correspondence Address: HAMILTON, BROOK, SMITH & REYNOLDS, P.C., 530 VIRGINIA ROAD, P.O. BOX 9133, CONCORD, MA, 01742-9133, US

(21) Appl. No.: 12/601,885

(22) PCT Filed: May 30, 2008
(86) PCT No.: PCT/US08/06843

§ 371 Date: Apr. 5, 2010

Related U.S. Application Data
(60) Provisional application No. 60/932,396, filed on May 31, 2007.

(51) Int. Cl. G06T 7/00

(52) U.S. Cl. 382/103

(57) ABSTRACT

Presented herein is a real-time target-locking confocal microscope that follows an object moving along an arbitrary path, even as it simultaneously changes its shape, size and orientation. This Target-locking Acquisition with Realtime Confocal (TARC) microscopy system integrates fast image processing and rapid image acquisition using, for example, a Nipkow spinning-disk confocal microscope. The system acquires a 3D stack of images, performs a full structural analysis to locate a feature of interest, moves the sample in response, and then collects the next 3D image stack. In this way, data collection is dynamically adjusted to keep a moving object centered in the field of view. The system's capabilities are demonstrated by target-locking freely-diffusing clusters of attractive colloidal particles, and actively-transported quantum dots (QDs) endocytosed into live cells free to move in three dimensions for several hours. During this time, both the colloidal clusters and live cells move distances several times the length of the imaging volume. Embodiments may be applied to other applications, such as manufacturing, open water observation of marine life, aerial observation of flying animals, or medical devices, such as tumor removal.

### RELATED APPLICATION

This application claims the benefit of U.S. Provisional Application No. 60/932,396, filed on May 31, 2007. The entire teachings of the above application are incorporated herein by reference.

### GOVERNMENT SUPPORT

The invention was supported, in whole or in part, by grants NAG 3-2284 from The National Aeronautics and Space Administration (NASA) and DMR-0243715 from the National Science Foundation (NSF). The Government has certain rights in the invention.

### BACKGROUND OF THE INVENTION

The advent of high-speed confocal microscope systems has allowed the rapid, three-dimensional imaging of a number of dynamic processes in physics, materials science and biology (P. J. Lu, “Confocal Scanning Optical Microscopy and Nanotechnology” in Handbook of Microscopy for Nanotechnology, N. Yao, and Z. L. Wang, eds. (Kluwer, 2005)), pp. 3-24; (P. J. Lu, J. C. Conrad, H. M. Wyss, A. B. Schofield, and D. A. Weitz, “Fluids of Clusters in Attractive Colloids,” Phys. Rev. Lett. 96, 028306 (2006)); (X. S. Xie, J. Yu, and W. Y. Yang, “Living Cells as Test Tubes,” Science 312, 228-230 (2006)).

Typically, a fixed three-dimensional volume within the sample is imaged periodically over time, which is normally adequate for samples and systems where objects remain within the field of view for a duration of an experiment. However, many investigations attempt to image dynamic phenomena, where an object of interest can move out of a three-dimensional imaging volume. In soft-condensed matter physics, for instance, free clusters of attractive colloidal particles typically diffuse out of view on timescales comparable to their growth or internal rearrangement (P. J. Lu, J. C. Conrad, H. M. Wyss, A. B. Schofield, and D. A. Weitz, “Fluids of Clusters in Attractive Colloids,” Phys. Rev. Lett. 96, 028306 (2006)).

In biology, many investigations require observation of processes involving freely-moving live cells, such as studies of motility or parasitic invasion (M. E. Wickham, M. Rug, S. A. Ralph, N. Klonis, G. I. McFadden, L. Tilley, A. F. Cowman, “Trafficking and assembly of the cytoadherence complex in Plasmodium falciparum-infected human erythrocytes,” EMBO J. 20, 5636-5649 (2001); B. Gligorijevic, R. McAllister, J. S. Urbach, and P. D. Roepe, “Spinning Disk Confocal Microscopy of Live, Intraerythrocytic Malarial Parasites. 1. Quantification of Hemozoin Development for Drug Sensitive versus Resistant Malaria,” Biochemistry 45, 12400-12410 (2006); B. Gligorijevic, R. McAllister, J. S. Urbach, and P. D. Roepe, “Spinning Disk Confocal Microscopy of Live, Intraerythrocytic Malarial Parasites. 2. Altered Vacuolar Volume Regulation in Drug Resistant Malaria,” Biochemistry 45, 12411-12423 (2006), for even a basic qualitative understanding. For these experiments, immobilizing the cells can interfere with the ability to answer the question of interest (T. A. Carnesano, M. J. Natan, B. E. Logan, “Observation of Changes in Bacterial Cell Morphology Using Tapping Mode Atomic Force Microscopy,” Langmuir 16, 4563-4572 (2000)); (N. Arhel, A. Genovesio, K-A. Kim, S. Miko, E. Perret, J-C. Olivo-Marin, S. Shorte, and P. Charneau, “Quantitative four-dimensional tracking of cytoplasmic and nuclear HIV-1 complexes,” Nat. Meth. 3, 817-823 (2006)). In whole-membrane investigations, for instance, surface-adhered areas of a cell membrane encounter a local chemical environment vastly different from the areas exposed to the medium.

An alternative approach is to target-lock by actively moving the sample to keep a moving object, such as a cell, in the center of the field of view; this enables observation for far longer periods of time. Well-established techniques can target-lock a single object in 3D at high speeds, treating it as an isolated point with no internal structure (H. Berg, “How to track bacteria,” Rev. Sci. Instrum. 42, 868-71 (1971); I. M. Peters, B. G. de Grooth, J. M. Schins, C. G. Figdor, and J. Greve, “Three dimensional single-particle tracking with nanometer resolution,” Rev. Sci. Instrum. 69, 2762-2766 (1998); G. Rabut, J. Ellenberg, “Automatic real-time three-dimensional cell tracking by fluorescence microscopy,” J. Microscopy 216, 131-137 (2005); V. Levi, Q. Q. Ruan, and E. Gratton, “3-D Particle Tracking in a Two-Photon Microscope Application to the Study of Molecular Dynamics in Cells,” Biophys. J. 88, 2919-2928 (2005); H. Cang, C. M. Wong, C. S. Xu, A. H. Rizvi, and H. Yang, “Confocal three dimensional tracking of a single nanoparticle with concurrent spectroscopic readouts,” Appl. Phys. Lett. 88, 223901 (2006); and T. Ragan, H. Huang, P. So, and E. Gratton, “3D Particle Tracking on a Two-Photon Microscopye,” J. Fluorescence 16, 325-336 (2006)). However, these single-point techniques are inherently poorly adept at following objects with prominent internal structure, or multiple objects moving independently.

### SUMMARY OF THE INVENTION

An example embodiment of the present invention includes a method and corresponding apparatus of target-locking. The method includes collecting a spatial three-dimensional (3D) data set representing objects dynamically changing in an imaging volume. The 3D data set is reconstructed to identify the objects within the 3D data set. The objects are analyzed to locate a geometric feature of at least one of the objects, and a geometric operation is performed to target-lock on an aspect of the geometric feature for a selectable length of time.

Collecting the 3D data set of objects may include confocal imaging the object multiple times to collect a series of successive, spatial, two-dimensional (2D) slices of the imaging volume. The objects may be dynamically changing in at least one of the following ways: translating in at least one spatial dimension within the imaging volume, rotating about at least one axis of the objects or of the imaging volume, scaling larger or smaller, dividing into identical or substantially identical objects or into other objects, or merging into fewer objects or with other objects. The geometric feature may be at least one visible or non-visible geometric feature, where the geometric feature may be selected from a group consisting of: position, orientation, number, size, radius of gyration, and polarization. Further, the polarization may be selected from a group consisting of: physical, magnetic and optical polarization.

Performing the geometric operation may include translating, rotating or magnifying the imaging volume. Alternatively, performing the geometric operation may include translating, rotating or magnifying the object. Further alternatively, performing the geometric operation may include translating or rotating the imaging system.

The geometric feature and corresponding aspects may be selected from geometric feature/aspect pairs in a group consisting of: center of mass of a largest cluster/geometric center; center of mass of a largest cluster/orientation; orientation/position; brightness/orientation; and orientation/physical feature. It should be understood that this list may be increased or different depending on an application or embodiment.

The method and corresponding apparatus may further include collecting a next 3D data set and then using that next 3D data set to reconstruct, analyze, and perform a next geometric operation to maintain target-lock on the aspect of the geometric feature. The method may further include dynamically increasing and decreasing magnification of the objects to maintain target-lock on the aspect of the geometric feature of the objects.

The method and corresponding apparatus may operate in real-time target-lock. The method and corresponding apparatus may be used to monitor objects under microscopic observation, macroscopic observation, or used in a medical device configured to observe objects dynamically changing inside a human or animal. Other example applications to which embodiments of the present invention may be applied are manufacturing, such as identifying defects in liquid-crystals or spatially anisotropic materials in microscopy, towed sonar arrays on unmanned nautical vehicles to track pods of swimming animals or traveling submarines in the ocean for long distances, radar or sonar arrays on unmanned aerial vehicles (UAV) for tracking groups (e.g., flocks, swarms) of flying animals (e.g., birds, bats, insects, etc.) for long distances, and tumor elimination in a patient that is, for example, held rigidly in a fixed position but the tumor is moving due to breathing or involuntary bodily motions or the patient has limited mobility and the tumor is either stationary or is moving due to breathing or involuntary bodily motions.

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIG. 1 is a system diagram illustrating an example embodiment of the present invention;

FIG. 2 is a diagram of multiple two-dimensional confocal images used to reconstruct a three-dimensional image of an object according to an embodiment of the present invention;

FIG. 3. is a system diagram of a target-locking acquisition with real-time confocal (TARC) microscope employing an embodiment of the present invention;

FIG. 4 is a timing diagram used to synchronize subsystems of the system of FIG. 3;

FIGS. 5A-5G are diagrams of freely diffusing clusters of colloidal spheres and information related thereto as observed by the TARC system of FIG. 3;

FIGS. 6A-6D are confocal images of a human lung cancer cell and quantum dots undergoing active transport and displacement plots related thereto;

FIG. 7 is a flow diagram of an example embodiment of the present invention;

FIG. 8 is another flow diagram according to another embodiment of the present invention;

FIG. 9 is a diagram of a medical device employing an embodiment of the present invention to observe an object (e.g., tumor) inside a human or animal;

FIG. 10 is a diagram of an oceanic application of an embodiment of the present invention; and

FIG. 11 is a diagram of an example embodiment employed in aerial target-locking of flying or swarming objects.

### DETAILED DESCRIPTION OF THE INVENTION

A description of example embodiments of the invention follows.

Described herein are example embodiments of systems and corresponding methods of Target-locking Acquisition with Real-time Confocal (TARC) microscopy or macroscopy, which can follow a collection of multiple objects as they move along arbitrary three-dimensional (3D) paths, even with significant changes in shape, size and orientation. Instead of following a single bright spot, the example embodiments may image multiple fluorescent objects, determine their positions and structure in three dimensions, and target-lock by moving the sample or steer abeam in response to geometric analysis of these data. The system integrates rapid image analysis with a data acquisition process so that the results of analyzing one 3D stack of images influence the collection of the next stack. In a departure from many confocal experiments, the volume the system images in the sample is not fixed in space, but, instead, is moved, or the beam is steered, in response to dynamic changes within the sample.

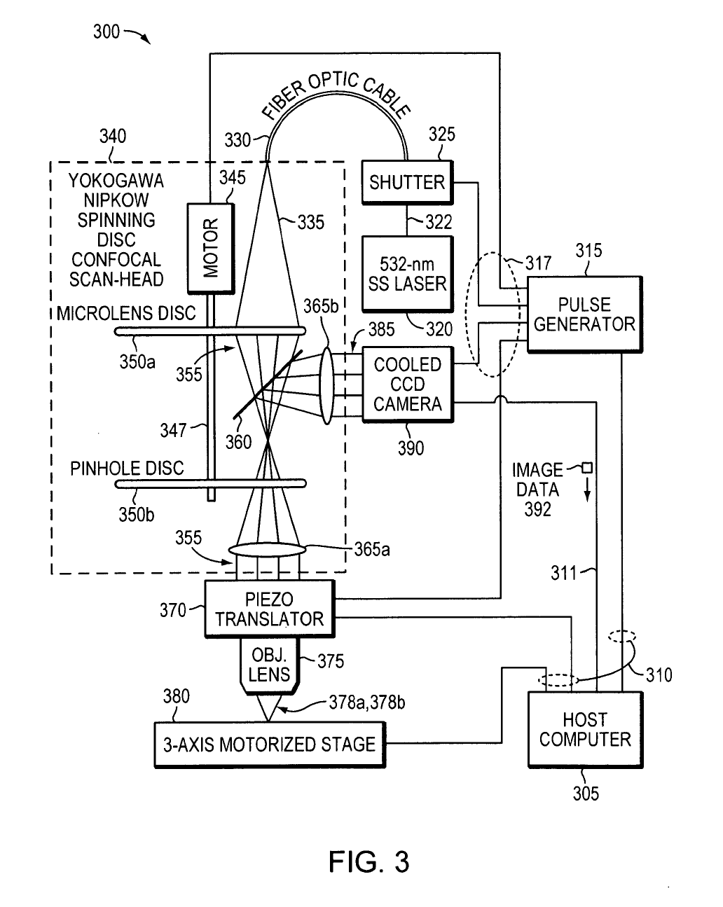

The TARC system is demonstrated herein, beginning in reference to FIG. 3, by target-locking two objects of interest: freely-diffusing clusters of attractive colloids, which change their shape, position, orientation and size throughout the experiment; and actively-transported quantum dots endocytosed into live cells free to move in three dimensions. It should be understood that many more objects of interest may be present in the same or other applications.

Example Materials and Methods

Example Apparatus Overview

To target-lock a moving object, an example embodiment of the TARC system in a microscope-based application first acquires a 3D stack of data, rapidly collecting a sequence of 2D confocal images from successive planes in the sample perpendicular to an optical axis. One particular implementation uses a Nipkow-disk confocal scanner (NCS) and Charge Coupled Detector (CCD) camera to collect these images, but any confocal, multi-photon or related technique may be equivalently used to acquire a 3D image stack. Next, the example system processes the images and performs a full structural analysis to identify and characterize the object it is target-locking. In some of the examples presented herein, the TARC system determines an exact position of the center of mass (COM) of the largest object in a sample and moves a microscope stage to bring that point to the center of a 3D imaging volume. A next 3D image stack is then acquired. Image collection and image analysis alternate, so that the results of analyzing one stack determine the position where the next stack is acquired.

In order to target-lock moving objects as quickly as possible, an NCS may be employed for high speed, and a piezo-based objective translator may also be employed to allow rapid access to different sample planes perpendicular to the optical axis. Separately, to reposition the imaging volume between imaging 3D stacks, i.e., at times when speed is not crucial, the microscope stage can be driven along three orthogonal axes with stepper motors.

A major challenge is coordinating actions of all hardware and software components quickly enough for effective target-locking. One particular issue with most NCS systems is that the disk spins freely at one rate, the camera acquires streaming images at a different rate, and there is no external synchronization between the two. This phase mismatch can significantly constrain the maximum frame rate; fringing Moire patterns, and eventually large overall intensity fluctuations, appear in the acquired images as frame rates increase. In addition, piezo-based microscope objective translation is usually controlled via software on a host PC in many commercial implementations, which does not allow the precise timing control to move the piezo during the few milliseconds after each frame when the camera is not collecting data.

Sufficient sub-millisecond timing precision cannot be achieved in software (e.g., using a Windows® based PC) alone, and attempts with an internal control board were swamped by electrical noise generated inside the PC. Instead, a demonstration system employing an embodiment of the present invention employs hardware external from the host PC for timing control, a custom pulse generator that triggers and synchronizes camera exposure, and a spinning-disk rotation rate and piezo translation with 10 microsecond temporal precision.

Before data collection begins, the host PC initializes and uploads control parameters to the camera, piezo controller, and pulse generator. The PC then signals the pulse generator to begin data collection. From that point onward, the PC receives camera images and analyzes them, moving the automated stage once per 3D stack to implement target-locking, but otherwise performs no timing control. The rest of the hardware is synchronized by the pulse generator.

Example Hardware Description

FIG. 3 is a block diagram of an example TARC system 300 according to an example embodiment of the present invention. The TARC system has hardware components and software components. The main optical components, such as a fiber optic cable 330, NCS 340, piezo transducer 370, and objective lens 375, are attached to an upright microscope (e.g., Leica DMRXA). Laser excitation is provided by a 532-nm Nd:YVO4 diode-pumped solid-state laser (CrystaLaser CGL-050-L) in an example implementation, with a shutter 325 controlled by a TTL signal (not shown) via one of multiple. TTL lines 317 from a pulse generator 315. A laser beam 322 is coupled into a single-mode (TEM₀₀) fiber 330, which delivers a few milliwatts, for example, of light into a commercial NCS 340 (e.g., Yokogawa CSU-10B).

Major components are indicated by black outline boxes. The system 300 includes an excitation beam path 335 system 300, one in the excitation beampath 335, 355 and an the emission beam path 385. A pair of lenses 365a, 365b is used in the system 300, one in the excitation beampath 335, 355 and the other in the emission beam path 385. The example system 300 includes TTL signal connections 317 electrically connecting the pulse generator 315 with the shutter 325, laser 320, cooled CCD camera 390, and piezo translator 370; RS-232 communications lines 310 connecting the host computer with the pulse generator 315, piezo translator 370, and three-axis motorized storage; and IEEE1394 firewire, connecting the CCD camera 390 with the host computer 305.

Internal components of the NCS 340 are depicted within a dotted grey rectangle in FIG. 3, briefly summarized here (see A. Egner, V. Andresen and S. W. Hell, “Comparison of the axial resolution of practical Nipkow-disk confocal fluorescence microscopy with that of multifocal multiphoton microscopy: theory and experiment,” J. Microscopy 206, 24-32 (2002); and E. Wang, C. M. Babbey and K. W. Dunn, “Performance comparison between the high-speed Yokogawa spinning disc confocal system and single-point scanning confocal systems,” J. Microscopy 218, 148-159 (2005); and references therein for discussion of the optical characteristics of this NCS). In the example NCS 340, two parallel disks 350a, 350b, one 350a with microlenses (not shown) and the other 350b with pinholes (not shown), are rigidly fixed to a single shaft 347 driven by a variable-speed motor 345. A motor controller (not shown) accepts a TTL pulse (not shown) from the pulse generator 315 via a TTL line 317 for synchronization (e.g., to phase-match an NTSC video signal), which is supplied by the pulse generator 315.

A beam 335 exiting the fiber optic cable 330 into the NCS 340 hits the upper disk 350a, which contains thousands of micro-lenses, and is split into numerous small mini-beams 355. The mini-beams 355 pass through a dichroic mirror 360 fixed between the two spinning disks 350a and 350b and are focused to a set of spots (not shown) surrounded by pinholes in the second disk 350b. The mini-beams 355 are then imaged by an objective lens 375 onto the sample (not shown) on a three-axis motorized stage 380, where the imaged mini-beams 378a excite fluorescence in the focal plane. The objective then focuses corresponding emission mini-beams 378b back through the pinholes in the lower disk 350b, which block light originating from other planes in the sample and thereby create confocal depth-sectioning. The Stokes-shifted emission mini-beams 378b are reflected by the dichroic mirror 360 and imaged via a second lens 365b as substantially parallel beams 385 onto a cooled-CCD camera 390 (e.g., QImaging Retiga 1394 EXi Fast). Rotating the disks 350a, 350b, which have a spiral pattern of microlenses and pinholes, moves the excitation mini-beams 355 within the sample focal plane in such a way to ensure uniform sample coverage.

The CCD camera 390 is configured by, and transfers image data 392 to, the host computer 305 via the IEEE1394 firewire 311, for example, but, in this example system 300, is triggered by separate electronically-independent TTL logic circuitry (not shown), accessed with signals (not shown) from the pulse generator 315. To ensure smooth data collection at high rates, the host PC 305 is equipped, in one embodiment, with a hardware-based RAID5 array of 10,000 rpm Ultra320 SCSI drives (Seagate). Because of the confocal pinholes, substantially only light from the focal plane of the objective lens 375 reaches the detector 390, so the objective lens 370 is physically translated to access planes at different depths within the sample.

Moving the objective lens 375 to different depths may be accomplished using a piezo-based microscope objective translator 370 (e.g., Physiks Instruments PiFOC) with a high-accuracy closed-loop controller (not shown) (e.g., Physiks Instruments E662K001), configured via RS232 by the host PC 305, but triggered separately with TTL logic pulses (not shown) from the pulse generator 315 via a TTL line 317. The PC 305 uploads a list of positions into a memory buffer (not shown) on the controller in the piezo translator 370 in one embodiment, and each time a TTL pulse is received from the pulse generator 315 (e.g., on a separate coaxial input (not shown), isolated from the RS232 lines 310), the piezo 370 moves to the next value in the list. In this way, a sequence of precise position's can be loaded and stored before the experiment begins, and accessed with great temporal precision via TTL triggering.

In an alternative embodiment, the volume of interest is raised or lowered, though it should be understood that inertia of the state 380 may make moving the volume of interest difficult within time frames for imaging the sample planes at different planes or the volume of interest is immobile or not under control of a stage (e.g., ocean life or aerial objects of interest).

Continuing to refer to FIG. 3, the pulse generator 315 contains a microcontroller (not shown) to manage RS232 communications with the host PC 305 via an RS232 Line 310, and a number of counters and comparators (not shown) implemented on several Custom Programmable Logic Devices (CPLDs) (not shown), which generate repeated bursts of pulses of programmable number, period, and delay output, to several TTL lines 317.

Continuing to refer to FIG. 3, the microscope stage 380 (e.g., Marzhauser) is controlled, independent of the piezo 370, by stepper motors (not shown) along three axes. The microscope stand's (not shown) electronic focus control moves the stage 380 up and down, along the z axis (the optic axis), while a separate controller (not shown) (e.g., Leica DMSTC) controls the x-y motion. Because the stage 380 is moved only once per 3D image stack in typical embodiments, precise timing control is not needed during movement stage of the 380. Therefore, the stage 380 may be controlled by software, such as via RS232, with no TTL triggering by the pulse generator 315.

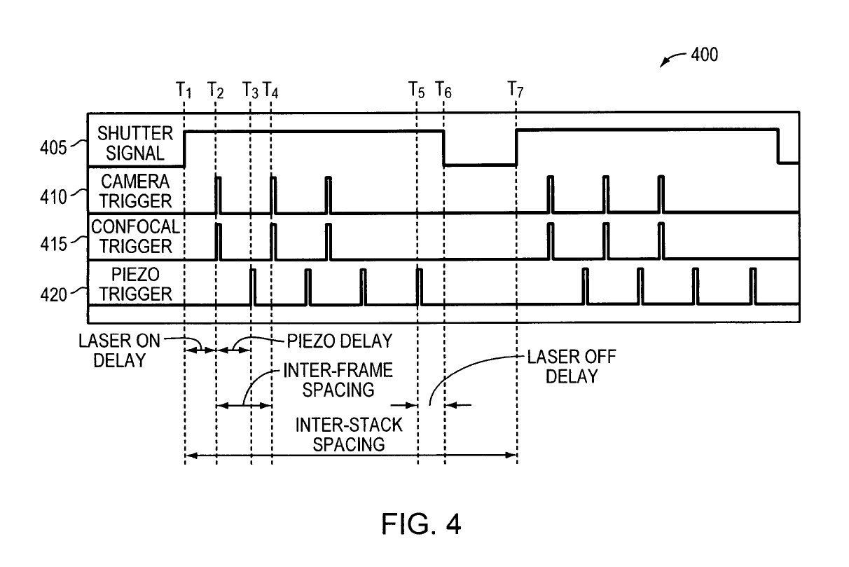

FIG. 4 is an example pulse sequence, showing relative timings of the TTL signals sent by the pulse generator 315 to the other parts of the TARC system 300. Referring to FIG. 4 with references to FIG. 3, the pulse generator 315, optionally in cooperation with other electronics, issues pulse sequences 405, 410, 415, 420 for the acquisition of two 3D image stacks, each with three images. Data acquisition begins at T₁, when the pulse generator 315 opens the laser shutter 325 by raising “Shutter Signal” 405 to a TTL-high value, which it maintains during the course of acquiring the first stack. At T₂, after delaying for “Laser On Delay” (T₂−T₁), the pulse generator 315 sends a “Confocal Trigger” 415/Camera Trigger 410” pulse to synchronize the confocal spinning disks 350a, 350b and begin exposure of the CCD camera 390.

At T₃, after delaying for “Piezo Delay” (T₃−T₂), the pulse generator 315 sends a “Piezo Trigger” 420 pulse to move the piezo 370 to the next position. At T₄, after delaying for Inter-frame Spacing (T₄−T₂) relative to T₂, the pulse generator sends another Confocal Trigger 415/Camera Trigger 410 pulse to start acquisition for the next frame. And again, the piezo 370 is then moved with a Piezo Trigger 420 pulse following the end of acquisition of the second frame, after a delay of Piezo Delay relative to T₄.

This process repeats for each frame in the 3D image stack. After the final frame in each stack is collected (i.e., the third frame here), the pulse generator 315 sends several more Piezo Trigger 420 pulses to move the objective lens 375 back to the starting increment in small steps. Note that with immersion objectives, mechanical coupling via the viscous index-matching liquid causes the sample to slip if the objective lens 375 is moved too quickly. After the final Piezo Trigger 420 pulse, when the objective lens 375 has returned to the starting position, the pulse generator 315 waits for Laser Off Delay (T₆−T₅) before dropping the Shutter Signal 405 back to the TTL-low value, cutting off the laser and preventing sample bleaching during the waiting time between stacks (T₇−T₆). At T₇, after a delay of Interstack Spacing (T₇−T₁) relative to the acquisition start of the previous stack at T₁, the shutter 325 is again opened, and the acquisition of the second 3D image stack commences.

Example Software Overview

Referring again to FIG. 3, a main acquisition program (not shown), executed in the host computer 305 in the example embodiment of FIG. 3, performs several functions: it initializes and configures the pulse generator 315 (with numbers and timings of the pulses), the piezo 370 controller (not shown) (e.g., with list of positions to move through when triggered), and the camera 390 (imaging parameters). Subsequently, the main acquisition program manages the data acquisition by writing individual image files to disk or other storage location, optionally via a network link (not shown), as soon as each 2D image is delivered via the firewire 311 from the camera 380.

Each image may be stored as a single compressed 8-bit grayscale TIF file, universally accessible from any image-editing program. This represents a significant departure from the operation of most commercial confocal implementations, which typically combine 2D images into 3D stacks in a temporary memory buffer before writing out huge, cumbersome, aggregated data files to disk. The size of this temporary buffer, typically a few gigabytes, is comparable to the amount of system RAM or OS-dependent, single-file, maximum size, and represents the largest amount of data that can be collected without interruption. By contrast, writing each 2D frame to disk individually requires only small megabyte-size memory buffers, which are then cleared and recycled immediately. The main acquisition program therefore executes in just a few megabytes of RAM, with continuous real-time data-streaming to disk limited only by total disk capacity. Images have been acquired continuously for days without interruption, resulting in tens of gigabytes of uninterrupted image data.

After each 3D image stack has been collected, the main acquisition program launches a wrapper program that manages the target-locking system 300 by calling several other programs to analyze the images and move the stage 380 in response. All programs execute from the command-line in one example embodiment to maximize speed and facilitate automated scripting, and, in a demonstration system, were written in platform-independent C++. Using fully object-oriented classes and wrappers not only abstracts the hardware details from the programmer, but also facilitates a completely modular software architecture for the analysis. In particular, while the image analysis protocol in this example target-locks by moving the stage 380 to keep the Center of Mass (COM) of the largest cluster of bright objects centered in the 3D imaging volume, any program that calculates a final stage displacement from analyzing 3D image data can be used in place of these routines, with only trivial changes to the wrapper program.

It should be understood that software used to implement an embodiment of the present invention may be written in any software language suitable to support operations as described herein. The software may be stored on any electronic medium to be loaded and executed by a general or application-specific processor configured to process data or interact with devices as described herein.

The above-described hybrid approach for 3D particle location identifies centroids in 2D images, largely based on a well-known algorithm (J. C. Crocker, and D. G. Grier, “Methods of Digital Video Microscopy for Colloidal Studies,” J. Colloid Interface Sci. 179, 298-310 (1996)), then links the text-data positions up afterward into full 3D positions. Processing only a single 2D image at a time in some example embodiments gives a number of performance advantages over the alternative approach of loading an entire 3D data set into memory at once. First, in one embodiment of the present invention, only a single image (of at most a few megabytes) resides in memory at any given time, instead of the hundreds of megabytes of a typical 3D stack. Second, some embodiments of the present invention may employ optimized image-processing libraries (not shown), used to increase performance, that are explicitly designed to work with 2D images, loading image data into the processor cache and parallel registers (not shown) in a particular way to accelerate filtering operations that, require access to adjacent rows of pixels; there is no corresponding method to do so for 3D data.

In the demonstration system, combining multi-threaded libraries with a vectorizing compiler (e.g., Intel) to take advantage of special features in recent processors yielded significant speed increases of several orders of magnitude relative to the standard implementations in MATLAB and Interface Description Language (IDL) even when compiled. This speed increase, resulting from the hybrid particle-location strategy and optimized code, ultimately enables the TARC system 300 to target-lock fast enough to be useful experimentally, with very modest requirements for the host PC 305, such as a 2 GHz Pentium 4 Xeon, 256 MB of RAM, Dell® used in the demonstration system.

Finally, note that trivially changing a configuration text file can set the TARC system 300 to acquire 3D image stacks with a fixed x-y-z displacement between stacks, without running any image analysis. This capability can be used for sampling a much larger area, for the following example reasons: to gain better statistics in a measurement, for tiling adjacent 3D image stacks to make large composite images, or to sample a predetermined pattern or matrix of 3D volumes in the sample. Thus, in addition to running with full target-locking, the TARC system 300 can also easily operate as a general-purpose, high-speed automated confocal acquisition system.

### Example Sample Preparation

To demonstrate the ability of the example TARC system 300 to properly target-lock highly anisotropic groups of objects over long times, we imaged aggregating clusters of attractive colloidal spheres (P. J. Lu, J. C. Conrad, H. M. Wyss, A. B. Schofield, and D. A. Weitz, “Fluids of Clusters in Attractive Colloids,” Phys. Rev. Lett. 96, 028306 (2006)). Colloidal 1.1 μm diameter spheres of polymethylmethacrylate (PMMA) with embedded DiIC1-8 fluorescent dye were suspended in a mixture of bromocyclohexane and decahydronaphthalene (Aldrich) in a proportion (nearly 5:1 by mass) that precisely matches the density of the particles, and sufficiently closely matches their index of refraction to enable confocal microscopy. Tetrabutyl ammonium chloride (Fluke), an organic salt, was added to screen Coulombic charge repulsion. Attraction between colloids was induced by the addition of nonadsorbing 11.6 MDa linear polystyrene (Polymer Labs), causing the colloidal spheres to aggregate into clusters several microns across, which diffuse as they continuously grow.

To demonstrate the capability to image living systems, we imaged live human lung cancer cells that actively transport endocytosed quantum dots (QDs) (X. L. Nan, P. A. Sims, P. Chen, X. S. Xie, “‘Observation of Individual Microtubule Motor Steps in Living Cells with Endocytosed Quantum Dots,” J. Phys. Chem. B. 109, 24220-24224 (2005)). Human lung cancer cells (A549) were cultured in Dulbecco's Modified Eagle Medium (DMEM, ATCC) supplemented with 10% fetal bovine serum (FBS) at 37° C. and 5 CO₂. For QD aggregate endocytosis, streptavidin-coated QDs (Invitrogen) with emission at 655 nm were combined with an equal volume of biotinylated poly-arginine (Invitrogen). The mixture was incubated at room temperature for 10 minutes, and the functionalized QDs were introduced to the cell culture at 200 pM. Following a one-hour incubation under normal culturing conditions, the medium was replaced and aggregate endocytosis was allowed to occur over 18 hours. In order to visualize the cell membrane, Alexa Fluor 532-labeled streptavidin (Invitrogen) was combined with the aforementioned biotinylated poly-arginine, and the resulting complex was introduced to the cell culture at about 1 nM one hour before imaging and incubated under the normal culturing conditions. Immediately prior to imaging, the cell culture was trypsinized, and the cells were introduced to the imaging chamber following trypsin inhibition.

To explore target-locking in faster-moving prokaryotic cells, we also imaged quantum dots inside E. coli. BL21(DE3)pLysS E. coli cells were grown to mid-log phase in standard LB medium in a 37° C. shaker. The cells were then incubated for one hour at room temperature following the addition of 1 nM streptavidin-coated quantum dots conjugated to biotinylated poly-arginine. The cells were pelleted by centrifugation at 1500 g for 10 minutes and re-suspended in fresh LB medium before imaging.

### Example Results and Discussion

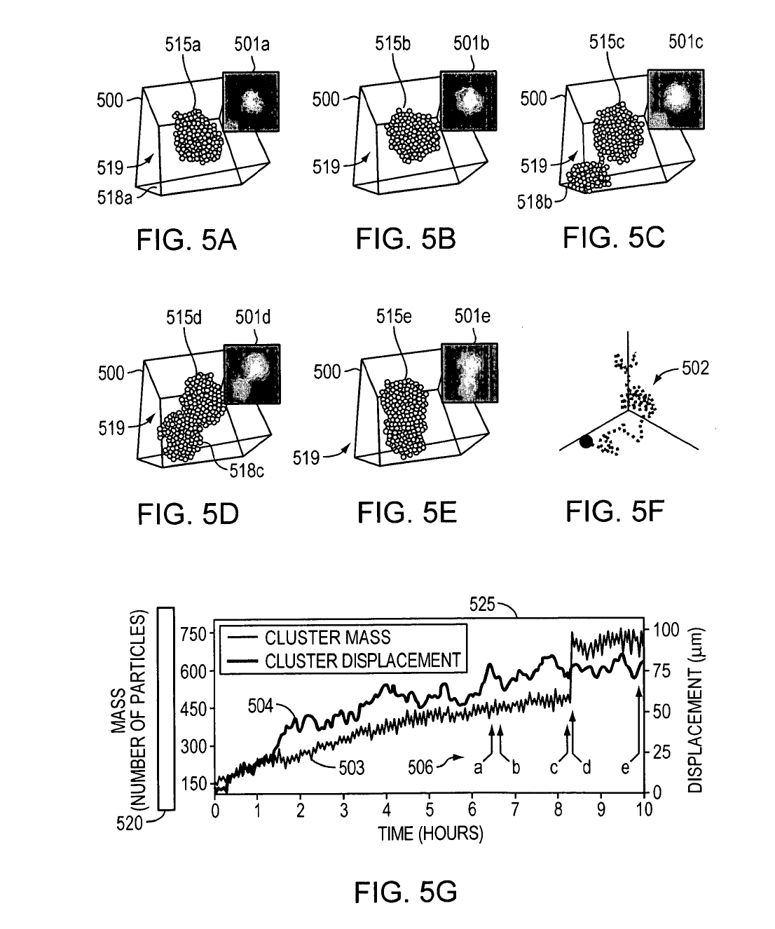

FIGS. 5A-5E are three-dimensional reconstructions based on spatial 3D data sets that include representations of objects of interest 515a-515e, other objects 518a-d, and background objects 519 in an imaging volume 500. The representations of objects of interest 515a-515e, other objects 518a-d, and background objects are observed to be changing dynamically over time in accordance with dynamic changes of the actual objects they represent.

In this example, the TARC system 300 was used for target-locking freely-diffusing clusters of colloidal spheres. FIGS. 5A-E illustrate 3D reconstructions and (inset) 2D confocal images (24×24 um²) of a growing cluster. In 3D reconstructions, monomers and dimers 519 are represented in transparent grey or other indication recognizable as representing such materials, and color or other indication of larger clusters 515a-e and 518a-c indicates their number of spheres, following a color bar or other indicator bar 520 at the left of the graph 525 in FIG. 5G.

During an extended imaging, dynamic changes may occur within the imaging volume 500, as represented in FIG. 5F. In FIG. 5A, a small cluster 518a enters the volume 500 in addition to the largest central cluster 515a, and the TARC system 300 properly follows the larger central cluster 515a after, as illustrated in FIG. 5B, the smaller cluster 518a has departed the imaging volume 500. Later, as illustrated in FIG. 5C, another small cluster 518b enters the volume 500 and, in FIG. 5D, merges with the central cluster 515d to form a much larger cluster, which, as illustrated in FIG. 5E as a new central cluster 515e, then rotates and contracts.

FIG. 5F is a 3D plot of the trajectory of the largest central cluster's 515a-e center of mass (COM). In all cases, the TARC system 300 successfully follows the largest cluster 515a-e in the imaging volume 500 and, as illustrated in FIG. 5G, determines the mass (number of particles; line 503 with relatively smooth increase and step indicating the merger of the clusters 515d, 518c to form a larger combined cluster 515e) and displacement of its center of mass relative to its initial position (line 504 with large fluctuations relative to the line 503 representing mass) through time. Arrows 506 indicate times at which images of the structures depicted in FIGS. 5A-5E were captured and reconstructed.

To produce the 3D reconstructions of FIGS. 5A-5E, the TARC system 300 imaged the colloidal clusters 515a-e and 518a-c with a 100× 1.4 NA oil-immersion objective (Leica), collecting and analyzing a 3D stack of 61 images, each 500×500 pixels, every 40 seconds. Image collection took 6 seconds, and analysis took <1 second for each stack. As shown in FIGS. 5A-5G, the TARC system 300 properly target-locked the freely-diffusing single central cluster under a variety of circumstances: when other, smaller clusters 518a-c entered and left the imaging volume 500 (FIGS. 5A and 5C); when two smaller clusters 515c, 518b, (FIG. 5C) and 515d, 518c (FIG. 5D) merged to form a single cluster 515e (FIG. 5E), dramatically changing shape and size (FIGS. 5C and 5D; and when a highly non-spherical cluster 515e changed orientation (FIGS. 5D and 5E). Proper target-locking was observed for 36,000 seconds (10 hours of which a full movie may be recorded and viewed in any desired mode, such as fast forward, zoom, or slow motion of interesting time periods, such as during mergers in FIGS. 5D and 5E, as the central cluster 515a-e diffused a distance many times its own length, and several times that of the 24×24×16 μm³ imaging volume (FIGS. 5F and 5G).

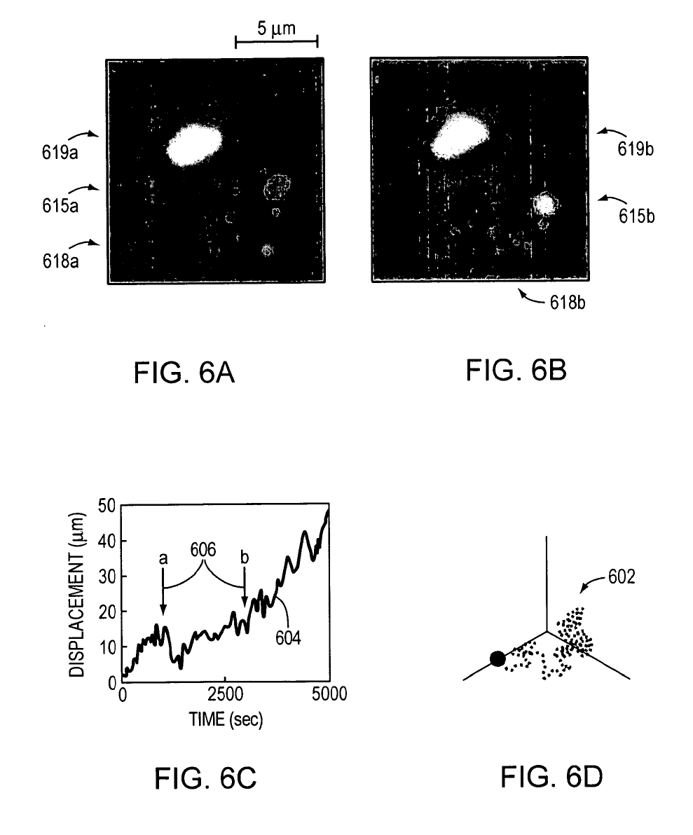

FIGS. 6A-6D are image and data plots of target-locking actively-transported Quantum Dots (QDs) in a freely-moving cell. FIGS. 6A and 6B are confocal images of a human lung cancer cell 619a and 619b, respectively, with cell membrane highlighted (in green in some display implementations), and quantum dots 615a, 618a (FIG. 6A) and 615b, 618b (FIG. 6B) undergoing active transport (in red in some display implementations) at 1020 seconds and 2950 seconds elapsed time in FIGS. 6A and 6B, respectively.

FIG. 6C is a plot of displacement versus time from original position, with arrows 606 indicating times depicted in FIGS. 6A and 6B.

FIG. 6D is a 3D trajectory plot of a path 602 in 3D of the center of the cell 619a, 619b.

To produce FIGS. 6A-6D, we imaged the live human lung cancer cells 619a, 619b with a 63× 1.2 NA water-immersion objective (Leica) at 37° C., collecting and analyzing 3D stacks of 61 images, each 300×300 pixels, every 10 seconds. Image collection took 6 seconds, and analysis took <1 second, for each stack. As shown in FIG. 6C, the TARC system properly target-locked the living lung-cancer cell 619a, 619b for more than 5,000 seconds (1.4 hours; a full movie may be recorded since the cell is target locked). During this entire time, we observed active transport of the vesicle-enclosed quantum dot aggregates 615a, 618a, and 615b, 618b, which moved significantly relative to the cell membrane 619a, 619b (FIGS. 6A and 6B), while the cell 619a, 619b itself moved 50 μm, many times its own length and that of the 14×14×13 μm³ imaging volume (FIGS. 6C and 6D). We also target-locked QDs absorbed by faster-moving E. coli by running at higher speeds, collecting and analyzing 3D stacks of 40 images every 5 seconds for several hours (data not shown).

In all of these examples, we collected ten 2D images per second with the CCD camera, limited by exposure time and readout speed. The host PC processed each 3D image stack in at most a few seconds, and often much faster, so our efficient image processing scheme probably did not limit the speed in these cases. Ultimately, it appears that the mechanical stability of the piezo objective translator limits 3D acquisition to around thirty 2D images per second (video rate). Maximizing for speed, we successfully acquired complete 3D stacks of 40 images, each 512×400 pixels, every 2 seconds with an EMCCD camera (QImaging), whose greater sensitivity permitted far lower exposure times than the standard cooled CCD. In all cases, the TARC system ran indefinitely, and we have target-locked colloid clusters continuously for more than a day, generating thousands of 3D stacks. This long-time stability is made possible by performing a full 3D reconstruction and locking onto a specific geometric feature determined in a complete structural analysis.

In an alternative embodiment, a partial 3D reconstruction may be performed by having a priori knowledge of a location in 3D where the geometric feature is to be able to target lock on a selected aspect thereof. Further, a partial 3D reconstruction can be done with a search to determine whether the geometric feature is within the partial 3D reconstruction; target-locking can be done on the aspect if the geometric feature is within the partial 3D reconstruction, or another partial reconstruction with search can be done if it is not.

The full 3D reconstruction and target-locking technique according to the example embodiments of the present invention disclosed herein is a significant advance over previous systems in which the image processing consists of finding the intensity maximum within the imaging volume and following it (G. Rabut, J. Ellenberg, “Automatic real-time three-dimensional cell tracking by fluorescence microscopy,” J. Microscopy 216, 131-137 (2005)). When multiple objects enter the imaging volume, systems with the approach of previous systems can lock onto a point, i.e., the effective center of intensity, that lies outside of all the fluorescent objects, and may subsequently lose the proper target. By contrast, as shown in FIGS. 5A-5G, the TARC system employing an embodiment of the present invention gracefully handles multiple objects coming in and out of the imaging volume, while keeping the largest cluster stably centered.

Moreover, target-locking onto any well-defined point within a cluster, selected by any number of other structural characteristics (e.g., radius of gyration, fractal dimension, or density) instead of the mass, can be done according to an aspect of the present invention by making trivial changes to the code and incurs no performance penalty. Even more generally, while the image analysis described herein specifically identifies clusters of fluorescent objects, it can be an independent program that executes separately from the main image acquisition program. This independence allows substitution of any analysis program, in any language, that takes a set of images as input and outputs a stage displacement. In this way, pre-existing image analysis routines, currently used to analyze data after image collection has ended, can be redeployed for active target-locking using an embodiment of the TARC system, thereby controlling the data acquisition process itself.

The examples herein highlight direct imaging, but the TARC system can also be used as a target-locking system orthogonal to primary data collection, operating through one microscope camera-port and periodically moving the stage to track a freely-moving object, while data is collected simultaneously with an entirely separate technique. And, as previously mentioned, while an NCS was chosen for several practical reasons, primarily high time resolution, the target-locking technique may also be applied to other types of confocal or multi-photon systems. Thus, the TARC system's designs and code enable new and unique contributions to understanding dynamic interactions in physics, materials science and biology, and can also be used in many other applications.

### Other Example Applications:

### I. Fluorescent Object Cluster in Confocal Microscope (as Described Above)

1. Data Collection Method: Confocal fluorescence microscopy

2. Geometric Feature: Center-of-mass of largest cluster of objects

3. Feature Aspect: Position

4. Geometric Operation: Spatial translation (displacement)

Uses:
A. Physics: Observe the internal dynamics of clusters, modeling atoms, for understanding generic behavior of clustering or aggregating systems. Allows quantitative characterization of internal dynamics of particles within a cluster: do they behave like a liquid, free to flow around each other, or are they arrested, or fixed, relative to each other, as in a solid glass? How does the geometry (fractal properties, degree of branching) change as clusters grow and connect to each other?
B. Biology: Observe freely-moving live cells, giving crucial information about processes that (i) take longer to occur than the cell will remain in a field of view at high magnification or (ii) will be inherently compromised by fixing a cell to a surface. Examples include motility, parasitic invasion, cell division, and whole-membrane investigations.

### II. Defects in Liquid-Crystals, or Spatially Anisotropic Materials, in Microscopy

1. Data Collection Method: Confocal microscopy, or polarization microscopy

2. Geometric Feature: Center of topological defect in a liquid crystal

3. Feature Aspect: Orientation and position

4. Geometric Operation: Rotation and translation
Uses: observing dynamic changes in polarization in a system comprising a number of anisotropic objects, whose orientations are individually free to rotate. This is useful to monitor and track the propagation of topological defects in liquid crystals, where both position and orientation are important aspects to track in response to changing conditions (both external stimuli and natural evolution of the system). Applications of this investigative method include the development of better, more responsive, liquid crystal materials for such technologies as liquid-crystal displays.

### III. Towed Sonar Arrays on Unmanned Nautical Vehicles to Track Pods of Swimming Animals in the Ocean for Long Distances

1. Data Collection Method: Sonar ranging from a towed sonar array
2. Geometric Feature: Center-of-mass and principle axis of a cluster of swimming animals (e.g., whales, dolphins, fish)
3. Feature Aspect: Position and orientation
4. Geometric Operation: Translation
Uses: Observe collective movements of a cluster (e.g., pod, school) of swimming animals (whales, dolphins, fish, etc.), where the average collective motion (position, direction, and velocities) is useful to be tracked. Geometric analysis is employed so that the behavior of a few stray animals does not affect the tracking of the group. Target-locking may be employed to track the position of these groups for long distances (i.e., greater than the extent of a single undersea fixed array, for which target-locking is not useful) to monitor, for instance, migrations across oceans. At a smaller scale, this technique is also useful for following movements in turbulent flow, such as ocean currents.

### IV. Radar or Sonar Arrays on Unmanned Aerial Vehicles (UAV) for Tracking Groups (e.g., Flocks, Swarms) of Flying Animals (e.g., Birds, Bats, Insects, Etc.) for Long Distances

1. Data Collection Method: Radar or sonar ranging from a UAV
2. Geometric Feature: Center-of-mass and principle axis of a cluster of flying animals (e.g., birds, bats, insects, etc.)
3. Feature Aspect: Position and orientation
4. Geometric Operation: Translation
Uses: Observe collective movements of a cluster (e.g., flock, swarm) of flying animals (e.g., birds, bats, insects, etc.), where the average collective motion (position, direction, and velocities) is to be tracked. Geometric analysis is useful so that the behavior of a few stray animals does not affect the tracking of the group. Target-locking may be employed to track the position of these groups for long distances (i.e., greater than the extent of a single fixed radar array, either ground-based or from a stationary or predictable flight path in the air, such as AWACS, for which target-locking is not useful) to monitor, for instance, long-distance migrations of birds across continents. Because of the increasing miniaturization of UAVs, the technique may be useful for following the movements of smaller objects, like a swarm of insects, whose size can be easily detected with local sonar, (such as how a bat uses sonar), while too small to observe with ground-based radar. This can be useful for locating how bee colonies are disappearing, or locust or other crop-destroying pests collective move.

### V. Tumor Elimination in a Moving Patient

1. Data Collection Method: Magnetic Resonance Imaging in a medical context
2. Geometric Feature: Center-of-mass of tumor
3. Feature Aspect: Position
4. Geometric Operation: Translation
Uses: Many tumors occur in parts of the body that are difficult to mechanically fix in place in the body of a living patient, for instance in the colon or stomach, where breathing causes the entire area to move by at least millimeters every second. These types of tumors are therefore inaccessible to radiation methods, such as the gamma knife, that offer a non-invasive means to elimination, because they cannot be reliably located and targeted. By combining such a radiative tumor destruction method with a non-invasive, real-time 3D imaging system, such as MRI or CT scanning, the position of the tumor can be determined in real time, and the patient's body (e.g., “floating” on a table that can be translated quickly) or the targeting of the radiative tumor destruction method, can be translated to keep centered on the tumor. This has several benefits. Side effects from destroying the healthy tissue around a tumor can be limited, as in a brain tumor, where the patient's head can be fixed; or the patient's head can be less restricted (without, for instance, the high-tension collars screwed into the head to rigidly fix its position; straps allowing a small amount of movement, but much greater comfort could be used). It also opens up these radiative methods to removing tumors that move far too much for prior art targeting to be accurate at all, such as in the stomach and colon.

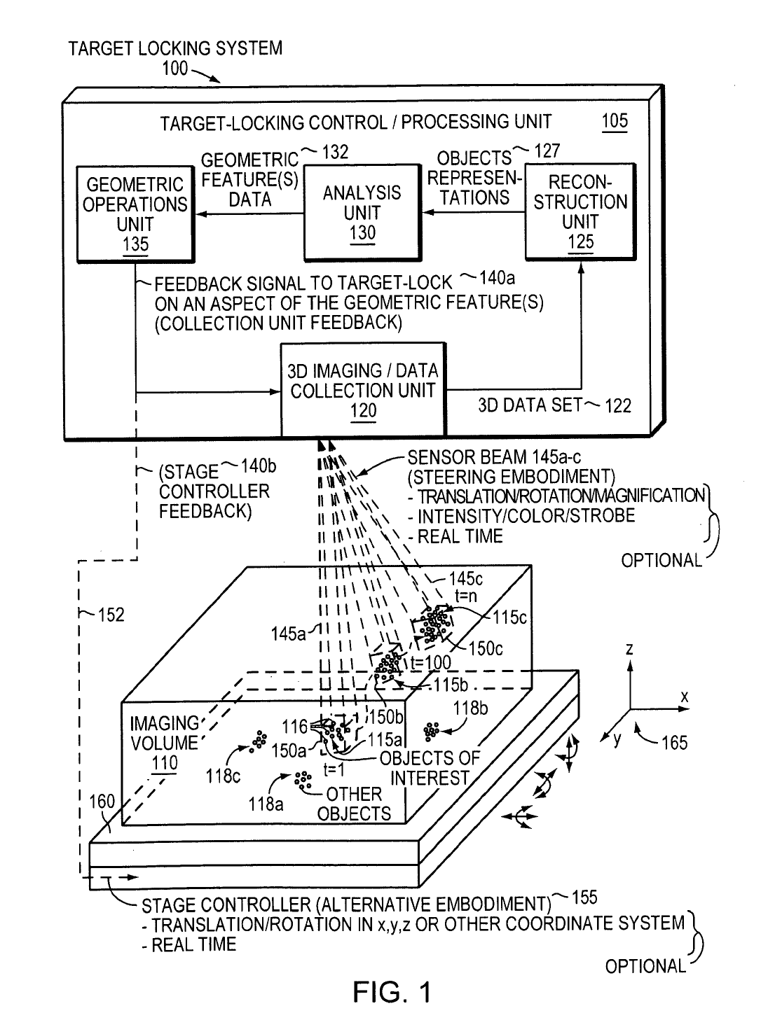

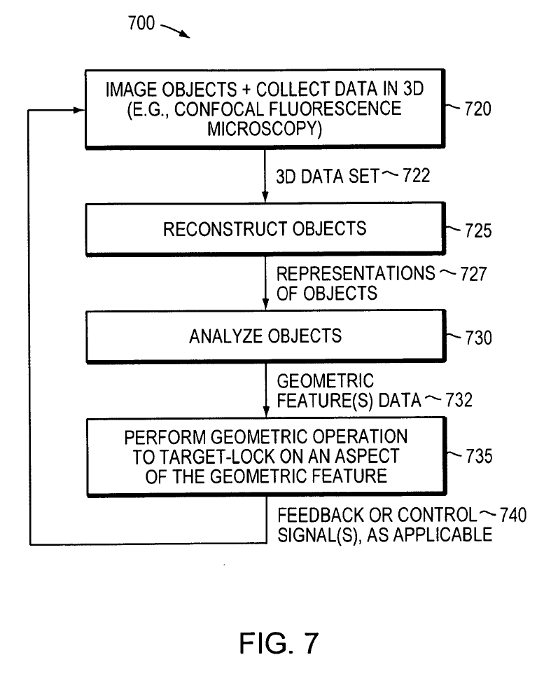

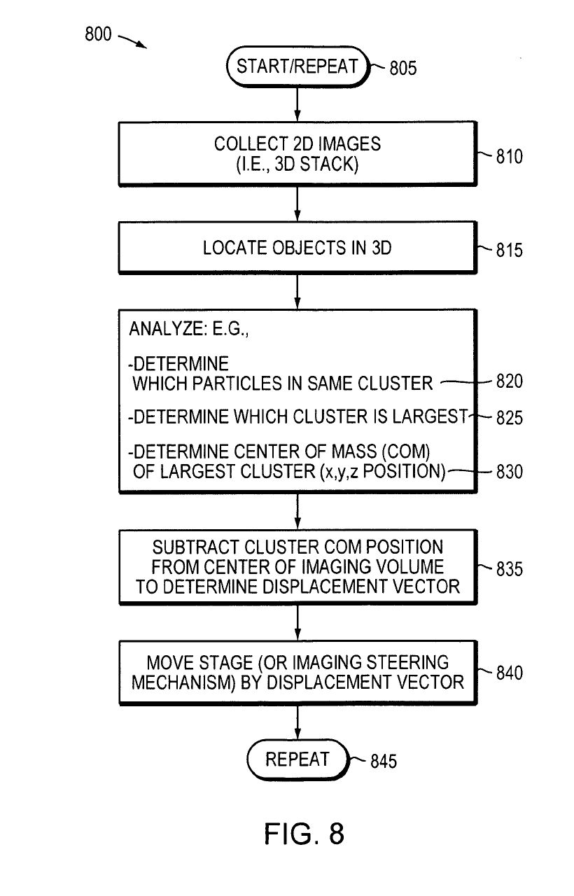

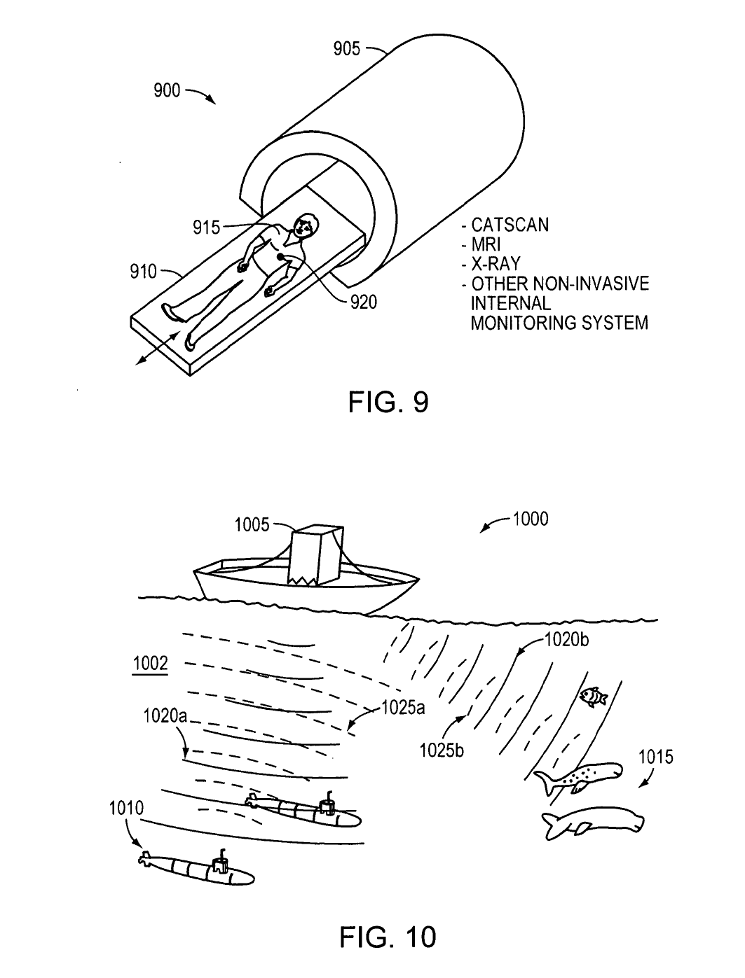

A specific example of a target-locking system (FIGS. 3-6D) and example applications beyond a confocal microscope were presented above. A generalized system is described below in reference to FIG. 1 and example flow diagrams in FIGS. 7 and 8 and applications in FIGS. 9-11 are also described below.

FIG. 1 is a diagram of an example target-locking system 100. The target-locking system 100 includes a target-locking/control processing unit 105 and optionally a stage controller 155. The target-locking control/processing unit 105 is positioned above, in this embodiment, an imaging volume 110, and the stage controller 155 is positioned below the imaging volume 110 to move the imaging volume 110.

Within the imaging volume 110 are clusters of objects of interest 115a-c, which are the same or similar objects at different points in time, and other clusters of objects 118a-c, which may be the same objects at different points in time or different objects. The clusters of objects of interest 115a-c and other cluster(s) of objects 118a-c are dynamically changing in the imaging volume 110 or can move out of the imaging volume 110 in applications in which the imaging volume 110 is unbounded.

The target-locking control/processing unit 105 includes electronics and, in some embodiments, optics, mechanics, and signal processors, to target-lock on an aspect of a geometric feature of the cluster of objects of interest 115a for a selectable length of time. The target-locking control/processing unit 105 includes a three-dimensional (3D) imaging/data collection unit 120, reconstruction unit 125, analysis unit 130, and geometric operations unit 135.

The 3D imaging/data collection unit 120 generates, in some embodiments, a sensor beam 145a-c, which are the same beam at different points in time, and collects images, such as florescence images of the cluster of objects of interest 115a-c produced by the cluster of objects of interest 115a-c as a result of being illuminated, such as optically or electromagnetically, by the sensor beam 145a-c. The collection unit 120, in turn, produces a 3D data set 122, which is provided to the reconstruction unit 125. The 3D data set 122 may be a series of 2D images, such as produced by a confocal microscope, based on which the reconstruction unit 125 produces a 3D image of objects in the form of objects representations 127. The object representations 127 are data of geometric feature(s) of the cluster of objects of interest 115a-c.

The analysis unit 130 analyzes the objects representations 127 and identifies geometric feature(s) 132 of the cluster of objects of interest 115a-c, where the geometric features 132 may be geometric features or of individual objects 116 composing the cluster of objects of interest 115a-c. The geometric operations unit 135 processes the geometric features 132 and produces a first or second feedback signal 140a or 140b to target-lock on an aspect of the geometric feature(s) 132. The first feedback signal 140a is provided to the collection, unit 120 in one embodiment, and the second feedback signal 140b is provided to the stage controller 155 via a communications path 152.

In operation, the target-locking control/processing unit 105 images the objects of interest 115a-c at t=1, . . . , t=100, . . . , t=n as the objects of interest 115a-c change dynamically over time within the imaging volume 110. In a first embodiment, the collections unit 120 moves its sensor beam 145a-c by steering the beam through use of mechanical or electrical techniques consistent with the type of imaging being performed. For example, in an optical imaging system, a steering mirror may be used to mechanically position a fiber or another technique for steering an optical sensor beam 145a-c to follow the objects of interest 115a-c over a selectable length of time may be employed. In an electromagnetic embodiment, such as radar, other steering techniques, such as phased array techniques, may be employed to steer a Radio Frequency (RF) sensor beam 145a-c.

Surrounding the objects of interest 115a-c is a representation of a subvolume 150a-c that the collection unit 120 images by using, for example, confocal microscopy to collect a series of successive spatial 2D slices of the subimaging volume (i.e., a portion of the imaging volume 110 in which at least a portion of the objects of interest 115 is during imaging. As the objects of interest 115a-c change dynamically within the imaging volume 110, the sensor beam 145a-c in the beam steering embodiment is steered as a function of the feedback signal 140a or 140b, and, during imaging, the sensor beam 145a-c is used to image the cluster of objects of interest 115a-c at a rate fast enough that the objects of interest 115a-c remain substantially fixed in position and orientation with respect to the rate at which they dynamically change in the imaging volume 110.

In the embodiment in which the 3D imaging data collection unit 120 has a fixed beam (e.g., beam 145a), the stage controller 155 moves a stage 160 that causes the imaging volume 110 to translate or rotate in an x, y, or z axis, as defined by a coordinate system 165. By moving the stage 160, the stage controller 155 keeps the cluster of objects of interest 115a, or portion thereof, within the subvolume 150a the collection unit has its sensor beam 145a directed.

In either example embodiment, the collection unit 120 may change the sensor beam 145a-c in intensity, color, or type, such as continuous wave or strobe, optionally with dynamically changing duty cycle. In either embodiment, the target locking system 100 may operate in a real-time manner and target lock on the cluster of objects of interest 115a-c for a selectable length of time by moving the sensor beam 145a-c or stage 160, at rates sufficient to target lock on at least a portion of the cluster of objects of interest 115a-c. It should be understood that in some embodiments, the target locking system 100 may employ both a collection until 120 that can steer the sensor beam 145a-c and the stage controller 155 to maintain target-lock on the cluster of objects of interest 115a-c in a coordinated manner.

The embodiment of the target-locking system 100 in which the collection unit 120 steers the sensor beam 145a-c may be used for applications in which the position or orientation of the imaging volume 110 cannot be controlled, such as for applications in which open water or aerial target-locking on objects of interest is performed. The embodiment in which the stage controller 155 controls movement of the stage 160 with imaging volume 110 can be used in examples, such as confocal microscope applications to image biological processes to target-lock on the objects of interest. The cluster of objects of interest 115a-c may be dynamically changing within the imaging volume 110 by translating in at least one spatial dimension within the imaging volume 110, rotating about at least one axis 165 of the cluster of objects of interest 115a-c or of the imaging volume 110, scaling larger or smaller, dividing into identical or substantially identical objects or into other objects, or merging into fewer objects or with other objects 118a-c, for example.

The cluster of objects of interest 115a-c, as described above, includes particular objects 116. The particular objects, or the cluster of objects of interest 115a-c in the cumulative, has a geometric feature that may be visible or non-visible. For example, the geometric feature may be a position, orientation, number, size, radius of gyration or polarization of a single or subset of objects 116 or the objects of interest 116 in the cumulative (i.e., cluster of objects of interest 115a-c). In the case in which the geometric feature is polarization, the polarization may be any form of polarization, such as a mechanical polarization, magnetic polarization, or optical polarization.

During target-locking, the geometric operations unit 135, based on the geometric features data 132, may, through use of the collection unit 120, steer the sensor beam 145a-c or stage controller 155 moving the imaging volume 110, to cause the imaging volume 110 to actually or effectively translate, rotate, or be magnified, where effectively translating, rotating, or magnifying the imaging volume means to change the sensor beam 145a-c in a corresponding manner.

The geometric feature and aspect of the cluster of objects of interest 115a-c can be defined in any physical or nonphysical manner. For example, the geometric feature may be a center of mass of a largest cluster of the objects of interest 115a-c and the aspect of the geometric feature on which target locking is performed is a geometric center of the center of mass of the largest cluster. In other embodiments the geometric feature/aspect may be: center of mass of a largest cluster/orientation, orientation/position, brightness/orientation, or orientation/physical feature. It should be understood that the geometric features/aspects are examples and are not intended to cover every possible physical or non-physical combinations that the target-locking control/processing 105 that can be used to target-lock on the cluster of objects of interest 115a-c.

As should be understood, the 3D imaging/data collection unit 120 collects the 3D data set 122, and the reconstruction unit 125, analysis unit 130, geometric operations unit 135 perform their respective processes on the cluster of objects of interest 115a-c at a particular time and may use the 3D data set 122 to collect a next 3D data set. That next 3D data set is then used to target-lock on the cluster of objects of interest 115 a-c to collect yet another 3D data set. The process of imaging and maintaining target-lock continues for a selectable length of time.

During the imaging (e.g., over seconds, minutes, hours, or days) 3D imaging/data collection until 120 may dynamically increase and decrease magnification of the cluster of objects of interest 115a-c to maintain target-lock on the aspect of the geometric feature of the objects. Moreover, the target-locking system 100 may operate in a real-time target-lock mode to monitor, for example, object of interest under microscopic or macroscopic observation. The target-locking system 100 may be used in several applications including a use in a medical device configured to observe objects dynamically changing inside a human or animal.

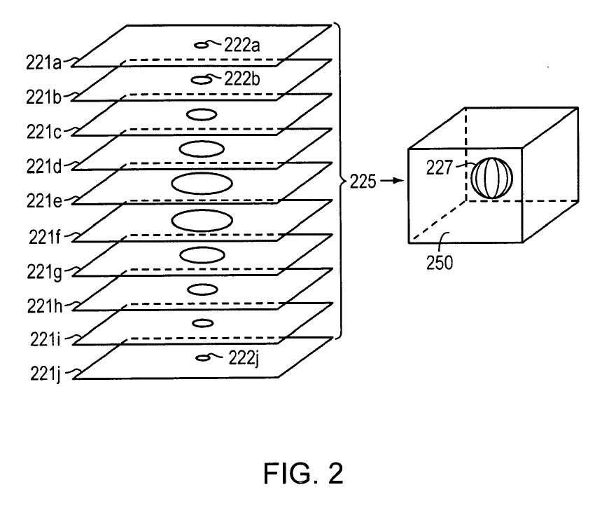

FIG. 2 is a perspective diagram of a series of two-dimensional (2D) images 221a-j. The 2D images 221a-j include respective “slices” of a respective object of interest 222a-j, which, when reconstructed 225, define a three-dimensional object 227 within an imaging volume 250, which may also be a sub-imaging volume, as described above in reference to FIG. 1. FIG. 2 may be produced by use of a confocal microscope that images a volume of interest in a successive series of imagings of a scan period, as described above in reference to FIG. 3. Alternative embodiments may include use of 2-photon microscopy in which thin sections (i.e., less than the imaging depth) are imaged.

FIG. 7 is a flow diagram 700 corresponding to an embodiment of the present invention. The flow diagram 700 images objects and collects data (720) in 3D, such as through use of confocal fluorescence microscopy, to produce a 3D data set 722. The flow diagram 700 then reconstructs objects (725) using the 3D data set 722 to produce representations of objects 727 being imaged. The flow diagram 700 then analyzes the objects (730) to determine geometric feature(s) data 732, and then performs at least one geometric operation (735) to target-lock on an aspect of the geometric feature. Feedback or control signal(s) 740, as applicable, are produced and delivered to a controller or used to steer an imaging beam for use in target-locking on object(s) of interest for further imaging. The flow diagram 700 then repeats with imaging objects and collecting data (720) in three dimensions.

FIG. 8 is a flow diagram 800 illustrating another embodiment of the present invention. The flow diagram 800 starts or repeats 805 and begins to collect 2D images (810), which, in the cumulative, form a 3D stack. Objects are then located (815) in 3D.

The flow diagram 800 may analyze representations of the objects to determine which particles, for example, are in the same cluster (820), determine which cluster is largest (825), and determine a center of mass (COM) of the largest cluster (e.g., x, y, z position) (830). The flow diagram 800 next subtracts a cluster COM position from the center of the imaging volume to determine a displacement vector (835). The flow diagram then moves a stage (or imaging steering mechanism) by the displacement vector (840). The flow diagram 800 then repeats 845.

FIG. 9 is an example application 900 in which an embodiment of the present invention may be applied as a tool for observing objects of interest inside a human 915 or other biological entity, such as an animal. The example application 900 includes a tunnel 905 in which a Cat Scan, MRI, x-ray or other non-invasive internal monitoring system may be employed. The human 915 is illustrated as lying on a movable platform 910 to position at least an area of the body in which the object of interest 920 is found. For example, the object of interest 920 may be a tumor, and the tunnel 905 may include both imaging and tumor destruction equipment. An embodiment of the present invention may be used to closely monitor a location of the tumor to maintain a focus by the tumor destruction equipment (not shown) to destroy the tumor in a non-invasive manner.

FIG. 10 is an open-water example application 1000 in which a boat 1005 employs a target-locking system according to an embodiment of the present invention that uses sonar signals 1020a, 1020b to collect 3D data on submarines 1010 or marine life 1015, such as whales, that are dynamically changing in the open water 1002. Through use of the target-locking system (not shown), personnel on the boat 1005 can target-lock, in realtime, on the objects of interest 1010, 1015 beneath the water.

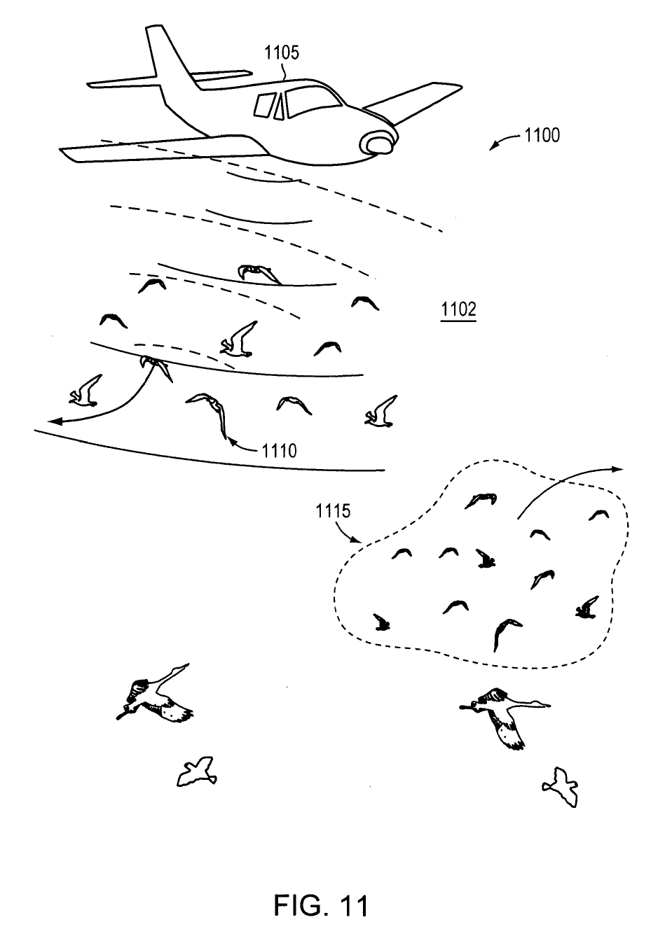

FIG. 11 is a diagram of an aerial application 1100 in which an airplane or other vehicle can target-lock on an object of interest 1110, 1115, such as a flock of birds or swarm of locust, for scientific research or other purposes. Through use of an embodiment of the present invention, the system can follow the objects 1110, 1115 moving along an arbitrary path even if it simultaneously changes its shape, size, or orientation.

It should be understood that how the system generates a 3D image, such as through 2D image stacks as described in reference to FIG. 2, may be designed based on the particular application in which the system is used. The principles of the present invention are not intended to be restricted to the examples disclosed herein.

While this invention has been particularly shown and described with references to example embodiments thereof, it will be understood by those skilled in the art that various changes in form and details may be made therein without departing from the scope of the invention encompassed by the appended claims.

What is claimed is:

1. A method of target-locking, comprising:
collecting a spatial three dimensional (3D) data set representing objects dynamically changing in an imaging volume;
reconstructing the 3D data set to identify the objects represented within the 3D data set;
analyzing a representation of the objects to locate a geometric feature of at least one of the objects; and
performing a geometric operation to target-lock on an aspect of the geometric feature for a selectable length of time.

2. A method according to claim 1 wherein collecting the 3D data set of objects includes confocal imaging the objects multiple times to collect a series of successive spatial two dimensional (2D) slices of at least a portion of the imaging volume.

3. The method according to claim 1 wherein the objects are dynamically changing in at least one of the following ways:
translating in at least one spatial dimension within the imaging volume, rotating about at least one axis of the objects or of the imaging volume, scaling larger or smaller, dividing into identical or substantially identical objects or into other objects, or merging into fewer objects or with other objects.

4. The method according to claim 1 wherein the geometric feature is at least one visible or non-visible geometric feature.

5. The method according to claim 4 wherein the geometric feature is selected from a group consisting of: position, orientation, number, size, radius of gyration, and polarization.

6. The method according to claim 5 wherein the polarization is selected from a group consisting of: physical, magnetic, and optical.

7. The method according to claim 1 wherein performing the geometric operation includes translating, rotating, or magnifying the imaging volume.

8. The method according to claim 1 wherein performing the geometric operation includes translating, rotating, or magnifying the objects.

9. The method according to claim 1 wherein performing the geometric operation includes translating or rotating at least a subset of imaging elements associated with collecting the spatial 3D data set.

10. The method according to claim 1 wherein the geometric feature/aspect are selected from pairs in a group consisting of:
center of mass of a largest cluster/geometric center;
center of mass of a largest cluster/orientation;
orientation/position;
brightness/orientation; and
orientation/physical feature.

11. The method according to claim 1 further including:
collecting a next 3D data set;
reconstructing the next 3D data set to identify the objects within the 3D data set;
analyzing the objects to locate the geometric feature of the at least one of the objects; and
performing a next geometric operation to maintain target-lock on the aspect of the geometric feature.

12. The method according to claim 1 further including dynamically increasing and decreasing magnification of the objects to maintain target-lock on the aspect of the geometric feature of the objects.

13. The method according to claim 1 operating in real-time target-lock.

14. The method according to claim 1 used to monitor objects under microscopic observation.

15. The method according to claim 1 used to monitor objects under macroscopic observation.

16. The method according to claim 1 used in a medical device configured to observe objects dynamically changing inside a human or animal.

17. An apparatus for target-locking, comprising:
a collection unit to collect a spatial three-dimensional (3D) data set representing objects dynamically changing in an imaging volume;
a reconstruction unit to reconstruct the 3D data set to identify the objects represented within the 3D set;
an analysis unit to analyze the a representation of objects to locate a geometric feature of at least one of the objects; and
a geometric operations unit to perform a geometric operation to target-lock on an aspect of the geometric feature for a selectable length of time.

18. The apparatus according to claim 17 wherein the collection unit includes a confocal imaging subsystem to image the objects multiple times to collect a series of successive spatial two dimensional (2D) slices of at least a portion of the imaging volume.

19. The apparatus according to claim 17 wherein the objects are dynamically changing in at least one of the following ways:
translating in at least one spatial dimension within the imaging volume, rotating about at least one axis of the objects or of the imaging volume, scaling larger or smaller, dividing into identical or substantially identical objects or into other objects, or merging into fewer objects or with other objects.

20. The apparatus according to claim 17 wherein the geometric feature is at least one visible or non-visible geometric feature.

21. The apparatus according to claim 20 wherein the geometric feature is selected from a group consisting of: position, orientation, number, size, radius of gyration, and polarization.

22. The apparatus according to claim 21 wherein the polarization is selected from a group consisting of: physical, magnetic, and optical.

23. The apparatus according to claim 17 wherein the geometric operations unit is configured to translate, rotate, or magnify the imaging volume.

24. The apparatus according to claim 17 wherein the geometric operations unit is configured to translate, rotate, or magnify the objects.

25. The apparatus according to claim 17 wherein the collection unit includes imaging elements and wherein the geometric operations unit is configured to cause at least a subset of the imaging elements to translate or rotate about the imaging volume.

26. The apparatus according to claim 17 wherein the geometric feature/aspect are selected from pairs in a group consisting of:
center of mass of a largest cluster/geometric center;
center of mass of a largest cluster/orientation;
orientation/position;
brightness/orientation; and
orientation/physical feature.

27. The apparatus according to claim 17 wherein:
the collection unit is configured to collect a next 3D data set;
the reconstruction unit is configured to reconstruct the next 3D data set to identify the objects within the 3D dataset;
the analysis unit is configured to analyze the objects to locate the geometric feature of the at least one of the objects; and
the geometric operations unit is configured to perform a next geometric operation to maintain target-lock on the aspect of the geometric feature.

28. The apparatus according to claim 17 wherein the collection unit includes an imaging subsystem and wherein the collection unit is configured to cause the imaging subsystem to increase and decrease magnification of the objects dynamically to maintain target-lock on the aspect of the geometric feature of the objects.

29. The apparatus according to claim 17 wherein the collection unit, reconstruction unit, analysis unit, and geometric operations unit are configured to operate in real-time target-lock.

30. The apparatus according to claim 17 configured to monitor objects under microscopic observation.

31. The apparatus according to claim 17 configured to monitor objects under macroscopic observation.

32. The apparatus according to claim 17 configured to operate within a medical device to observe objects dynamically changing inside a human or animal.

33. An apparatus for target-locking, comprising:
means for collecting a spatial three dimensional (3D) data set representing objects dynamically changing in an imaging volume;
means for reconstructing the 3D data set to identify the objects represented within the 3D data set;
means for analyzing a representation of the objects to locate a geometric feature of at least one of the objects; and
means for performing a geometric operation to target-lock on an aspect of the geometric feature for a selectable length of time.
